(19) United States
(12) Patent Application Publication
(10) Pub. No.: US 2012/0204269 A1
(43) Pub. Date: Aug. 9, 2012

(54) SECURE AUTOMATED FEATURE LICENSE UPDATE SYSTEM AND METHODS

(75) Inventors: Christopher P. Gardner, San Diego, CA (US); Paul D. Baker, San Diego, CA (US); Tat Keung Chan, San Diego, CA (US); Ted R. Michaud, Medford, NJ (US); Xin Qiu, San Diego, CA (US); Jinsong Zheng, San Diego, CA (US)

(73) Assignee: General Instrument Corporation, Horsham, PA (US)

(21) Appl. No.: 13/364,791

(22) Filed: Feb. 2, 2012

Related U.S. Application Data
(60) Provisional application No. 61/439,206, filed on Feb. 3, 2011.

(51) Int. Cl. G06F 21/00

(52) U.S. Cl. 726/26

(57) ABSTRACT

A method for providing a secure automated feature license update is disclosed. This method may be performed at a central license server. A license template including features for enablement on a device is generated. The license template is sent to an authorized user. A license update request is received from an entity. An updated license is generated by the central license server. A response is sent to the entity.

A method for providing a secure automated feature license update is disclosed. This method may be performed at a device, e.g. an end-user device. A first feature set of a current license of a device is compared with a second feature set of a license template received by the device. A license update request is generated when there is a difference between the first feature set and the second feature set. The license update request is sent to a license server.

### STATEMENT OF RELATED APPLICATIONS

This application claims the benefit of U.S. Provisional Patent Application Ser. No. 61/439,206, filed Feb. 3, 2011, which is incorporated herein in its entirety.

This application is related to co-pending U.S. patent application Ser. No. 13/021,380, filed on Feb. 4, 2011, which is based on U.S. Provisional Patent Application No. 61/302,072, filed on Feb. 5, 2010, both of which are incorporated herein in their entirety.

This application is related to co-pending U.S. patent application Ser. No. 13/238,850, filed on Sep. 21, 2011, which is based on U.S. Provisional Patent Application No. 61/384,996, filed on Sep. 21, 2010, both of which are incorporated herein in their entirety.

### BACKGROUND

As technologies advance rapidly, manufacturers are adding an increasingly large number of features to their products. Since customer needs vary over a wide range and constantly evolve, it is necessary for manufacturers to implement systems that can handle the customization of features for the initial configuration of and the subsequent changes in the product feature set.

There are relationships among elements of product feature information for different product lines. For example, multiple products may be associated with a product line. The feature set for a product may include multiple features. A feature rule set and a default feature set may be associated with each product.

In some implementations there may be rules of association among the various elements. For instance, a product will generally belong to one product line, whereas a feature may be associated with one or more products. Likewise, a feature rule set specifies any interdependencies that may exist among features. For example one rule in the rule set may specify that a product may include feature 1 only if the product also includes feature 2. Accordingly, all features specified in a rule set associated with a product must be available for that product. Each product will typically have a default feature set and the features included in the default feature set must be available for that product.

A manufacturer of mobile phones such as Motorola, for instance, may offer mobile phones that are capable of supporting a number of features in addition to voice such as data, texting, GPS services, Wi-Fi connectivity, web browsing, text-to speech and so on. In addition, features within larger applications, e.g. web browsing, may additionally support features such as private browsing. Likewise, data may be an enabled feature and internal features of different speeds and communications bands may also be enabled. The direct customers of the manufacturer, who in the case of mobile phones are often service providers such as Verizon and ATT, for instance, may wish to obtain mobile phones with different combinations of these features in order to meet the varying needs of the end users.

Another example includes a manufacturer of set top boxes, such as Motorola, for instance, who may offer set top boxes that are capable of supporting a number of features in addition to simple cable programming. The direct customers of the manufacturer, who in the case of set top boxes are often service providers such as ComCast or Cox, for instance, may wish to obtain set top boxes with different combinations of these features in order to meet the varying needs of the end users.

To address this issue, manufacturers have turned to feature licensing, which provides a feature control mechanism that allows customers to obtain a license to enable only the product features that meet their specific needs. Feature licensing brings many benefits to both manufacturers and customers. For example, feature licensing allows manufacturers to have a single build of a product that incorporates all available features and rely on feature licensing to enable different combinations of features. In addition, customers can get the exact features for a product that meets their specific needs without having to pay for undesired features. Feature licensing also allows manufacturers and customers to manage product upgrades and downgrades through license changes, eliminating the need to deploy different product versions and reducing operational downtime.

To achieve such benefits, however, different manufacturers, and even different organizations within the same manufacturer, have tended to build their own feature licensing systems to support their own product lines. These systems are often designed with only one or a few similar product lines in mind, and consequently cannot be easily extended to support other product lines. Once such custom-designed systems are developed, they need to be individually maintained and supported. Such repeated efforts result in increased cost in product development, deployment and support.

A generic feature licensing system can be provided that can support different product lines, which may include product lines from multiple manufacturers and not just from a single manufacturer. Such a generic feature licensing system may be operated and supported by a third party. Users of such a system may include users associated with the manufacturers, operators of the system who support and maintain the system, and customers who will be using the various features of a product for which licenses are being obtained. Customers may include, by way of example, service providers and/or the consumer end user.

The generic feature licensing framework may be used to service the licensing needs of different kinds of customers who purchase and operate products from manufacturers. For example, one type of customer may be a service provider who purchases a large number of end user devices, e.g. cable set top boxes, and deploys the end user devices to end users, e.g. cable service providers. Typically, the initial feature licenses for the end user devices are provisioned onto the devices in factories. After the devices are deployed to end users, a service provider may wish to enable features on the deployed devices that were not authorized by the initial license installed in the factories. A new license for each device that authorizes the additional features would need to be obtained by the service provider. In addition, a new license would need to be delivered to, and installed on, each device. A manual approach is impractical due to the large number of deployed devices.

This problem calls for an automated feature license update system for a service provider to obtain, deliver, and install updated licenses for a large number of deployed devices.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates one embodiment of components of secure automated license update system 100;

FIG. 2 illustrates one embodiment of a system 200 showing the importing of device initial licenses into the CLS either automatically or manually;

FIG. 3 illustrates one embodiment of a license update method 300 using a license proxy server;

FIG. 4 illustrates one embodiment of a license update method 400 using a license template distribution server;

FIG. 5 illustrates a method 500 for providing a secure automated feature license update;

FIG. 6 an embodiment of a method 600 for receiving an updated license;

FIG. 7 illustrates an embodiment of a method 700 for receiving a license response;

FIG. 8 illustrates an embodiment of a method 800 for receiving an updated license;

FIG. 9 illustrates an embodiment of a method 900 for receiving a license response;

FIG. 10 illustrates a method 1000 for providing a secure automated feature license update;

FIG. 11 illustrates one embodiment of a method 1020 for generating an updated license;

FIG. 12 illustrates one embodiment of a method 1115 for determining whether a service provider has enough available feature credits to fulfill a license update request;

FIG. 13 illustrates one embodiment of a method 1300 for calculating a feature credit cost;

FIG. 14 illustrates an example feature credit calculation method 1400;

FIG. 15 illustrates an exemplary server device 1500; and

FIG. 16 illustrates an exemplary end-user device 1600.

### DETAILED DESCRIPTION

### Definitions

The term Device refers to a single instance of a product which uses a license to enable its features. A device may be a physical piece of hardware with software running on it or it may be limited to just a software implementation.

The term Feature refers to a form of software or hardware functionality which may be enabled or disabled independently. Features may also have dependencies. Such as Feature A requires Feature B. Or as an example, a feature may represents the number of clients allowed. Another feature may represent the number of clients allowed for a particular platform. See Framework patent for more information. Features can also control capacity or capability, not just enabled/disabled. A single feature may also be used to control a set of features (feature A enables sub-features B, C, and D).

The term Feature Credit refers to a purchased denominator for how many instances of a particular feature may be enabled across all devices a customer operates. There may be a linkage between the feature credits and the product and company they belong to (features can only be used for a specific product and only by a particular company's devices). There may be other linkages that are also invoked such as geographical location, manufacturing year, or any other grouping desired.

The term License refers to a piece of data in a format that can authorize a specific device to enable a specific set of features and contains further information to protect the data against tampering. This further information may be an RSA signature. The RSA signature is also used to authenticate that the license is from the CLS and is for a particular product.

The term License Template refers to a piece of data that contains the features a device should have. A license template contains further information that protects the data against tampering and proves authenticity. This further information may be an RSA signature.

The term License Update Request refers to a request to generate a license by the Central License Server. A license update request is generated by a device and includes a license template and a means of securely identifying the specific device, such as a certificate containing an identifier unique to the device. The request may be signed by a device private key and contain a certificate linked to the device private key that authenticates against a known certificate authority that the CLS trusts for that device's product line. The request may also be signed by a key and have a certificate that is globally used by all devices in the product line thereby allowing the CLS to verify the signatures from the key for the specific product line. Using the aforementioned combinations of keys and certificates protects data against tampering.

The term License Response refers to a response to a license update request generated by the Central License Server. A license response is sent to a device in response to its license update request. It includes the ID of the device, a status code and may include a license, among other information.

The term CLS refers to Central License Server.

The term LPS refers to License Proxy Server, which is a computer that belongs to a customer, provides the customer identity to CLS, and serves as a proxy between individual devices and CLS.

The term LTDS refers to License Template Distribution Server, which is a computer server that belongs to a customer in their operated network, and provides a central access point for all the customer's devices to receive updates from the customer.

The term FLPS refers to Factory License Personalization Server, which is a computer server that generates the initial license of devices in factories where the devices are manufactured.

The term Customer refers to a user or company that purchased devices from a manufacturer and operates or supports the devices, which use feature licensing. The customer is a direct user of the CLS and maintains an LPS or LTDS.

The term End User refers to an individual who uses a device which uses feature licensing. An end user is not responsible for maintaining or updating the license on the device.

The term License Personalization Request is a request sent from a device to a factory license personalization server that contains the device ID and a license template.

A method for providing a secure automated feature license update to a selected network and devices is disclosed. This method may be performed at a device, e.g. an end-user device. A first feature set of a current license of a device is compared with a second feature set of a license template received by the device. A license update request is generated when there is a difference between the first feature set and the second feature set. The license update request is sent to a license server.

In one embodiment, the license update request includes the received license template and a secure identifier of the device. The request may be signed by a device private key and contain a certificate linked to the device private key that authenticates against a known certificate authority that the CLS trusts for that device's product line. The request may also be signed by a key and have a certificate that is globally used by all devices in the product line thereby allowing the CLS to verify the signatures from the key for the specific product line. Using the aforementioned combinations of keys and certificates protects data against tampering.

In one embodiment, the license server is a LPS, and the license template is received by the device from the LPS. An updated license is received from the LPS. The device verifies that the updated license is from a central license server, and is for the device. Based on the verification step, the updated license is installed on the device and the previous current license is deleted. Features authorized by the updated license are enabled on the device.

In one embodiment, the license server is a LPS, and the license template is received by the device from the LPS. A license response is received from the LPS. The license response has at least one of an updated license and a status. The device verifies that the license response is from a central license server. The device also verifies that the updated license is from the CLS and is for the device. Based on the verification step, the updated license is installed on the device and the previous current license is deleted. Features authorized by the updated license are enabled on the device.

In one embodiment, the license server is a central license server, and the license template is received by the device from a LTDS. An updated license is received from the CLS. The device verifies that the updated license is from the CLS and is for the device. Based on the verification step, the updated license is installed and the previous current license is deleted. Features authorized by the updated license are enabled on the device.

In one embodiment, the license server is a central license server, and the license template is received by the device from a LTDS. A license response is received from the CLS. The license response has at least one of an updated license and a status. The device verifies that the license response is from the CLS. The device also verifies that the updated license is from the CLS and is for the device. Based on the verification step, the updated license is installed and the previous current license is deleted. Features authorized by the updated license are enabled on the device.

A method for providing a secure automated feature license update is disclosed. This method may be performed at a CLS. A license template including features for enablement on a device is generated. The license template is sent to an authorized user. A license update request is received from an entity. An updated license is generated by the CLS. A response is sent to the entity.

In one embodiment, the entity is a license proxy server. The response may either be the updated license or a license response where the license response comprises at least one of an updated license and a status. In one embodiment, a license response includes only a status, e.g. when an error occurs and the license update cannot be generated.

In one embodiment, the entity is a device, e.g. an end-user device. The response may either be the updated license or a license response where the license response comprises at least one of an updated license and a status. In one embodiment, a license response includes only a status, e.g. when an error occurs and the license update cannot be generated.

The license template may be protected against alteration. The license template can also be verified to have originated from the central license server. The license template is signed by a unique product key. This signature prevents tampering and defines the scope of the authorization. The license template is valid for a certain product because it uses the product's signing key.

In one embodiment an updated license is generated. A service provider for the license update request is determined. The license update request is validated. A determination is made as to whether the service provider has enough available feature credits to fulfill the license update request.

In one embodiment, a determination is made as to whether a service provider has enough available feature credits to fulfill a license update request. A current license for the device is looked up. A feature credit cost to update the license is calculated.

The following capabilities may be implemented using the principles of this disclosure: 1) different products (or applications) and different product (or application) features are all licensable; 2) different applications or products may have their own credit handling business logic and rules linked to the process of upgrading their features (this is enforced by the CLS and examples include: i) how feature credits are refunded; and ii) whether a pre-paid or post-paid method of acquiring features is used, among other rules); 3) the system provides a secure mechanism to allow the authorized upgrade/downgrade of a large volume of deployed devices in a network.

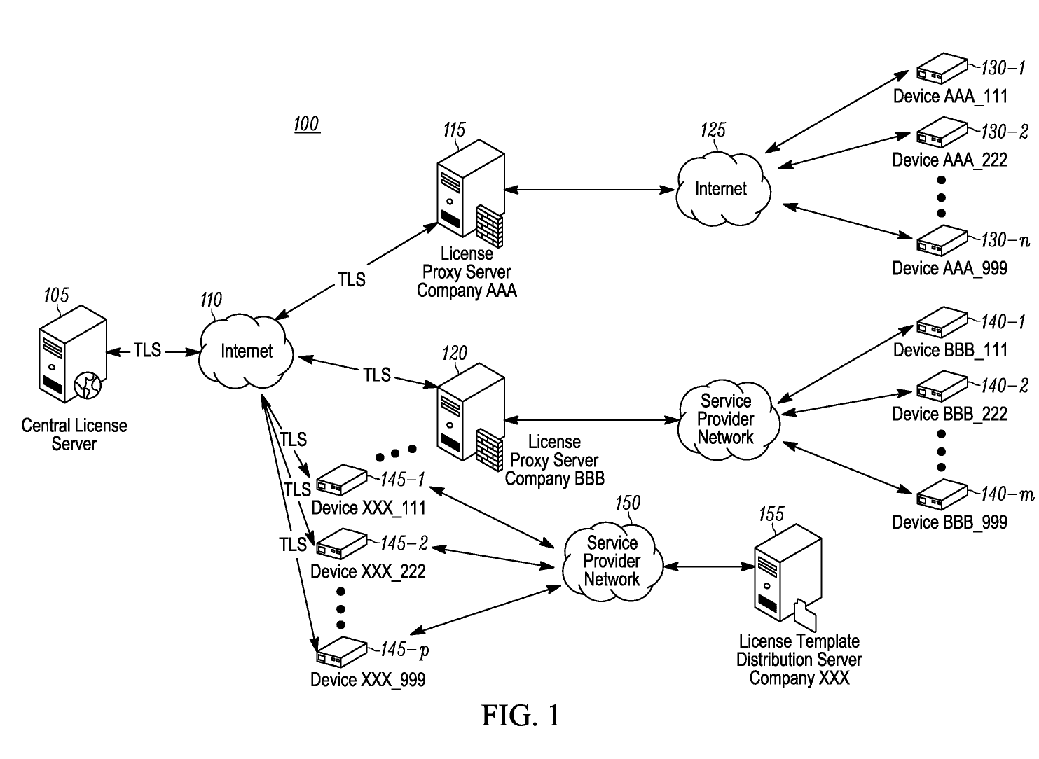

FIG. 1 illustrates one embodiment of components of secure automated license update system 100. The system 100 is comprised of one CLS 105, multiple LPS 115, 120 that belong to different customers who are typically service providers, multiple LTDS, e.g. LTDS 155, that belong to different customers, and devices (devices 130-1, 130-2, . . . , 130-n; devices 140-1, 140-2, . . . , 140-m) that are deployed by customers in end user premises but maintained and supported by the customers. CLS 105 can support multiple customer companies. Devices (devices 130-1, 130-2, . . . , 130-n; devices 140-1, 140-2, . . . , 140-m) may connect to an LPS (shown as LPS 115) through a public wide area network (WAN) 125 such as the Internet or to an LPS (shown as LPS 120) through a service provider's private network. In one embodiment, connections over WAN may be established in a virtual private network (VPN).

Every LPS 115, 120 across all customer companies connects to the CLS via the Internet 110. The connection between an LPS 115, 120 and CLS 105 may be encrypted using transport layer security (TLS).

Devices (devices 145-1, 145-2, . . . , 145-p) that connect to LTDS 155 may do so through a public WAN such as the internet (not shown) or through a service provider's private network 150 (using LTDS 155). Devices (devices 145-1, 145-2, . . . , 145-p) which connect to LTDS 155 connect to CLS 105 via the Internet. The connection between a device (devices 145-1, 145-2, . . . , 145-p) and CLS 105 may be encrypted using TLS.

CLS 105 needs to know the current set of features on a device so that feature credits will be credited or deducted properly when handling the license update request. For CLS 105 to know the initial feature set of a device, either the device's initial license or the device's factory license personalization request needs to be imported into CLS 105. If factory license personalization requests are imported into the CLS, the CLS will regenerate the initial licenses based on the templates in those requests. In the remainder of the discussion, it is assumed that device initial licenses are imported into the CLS.

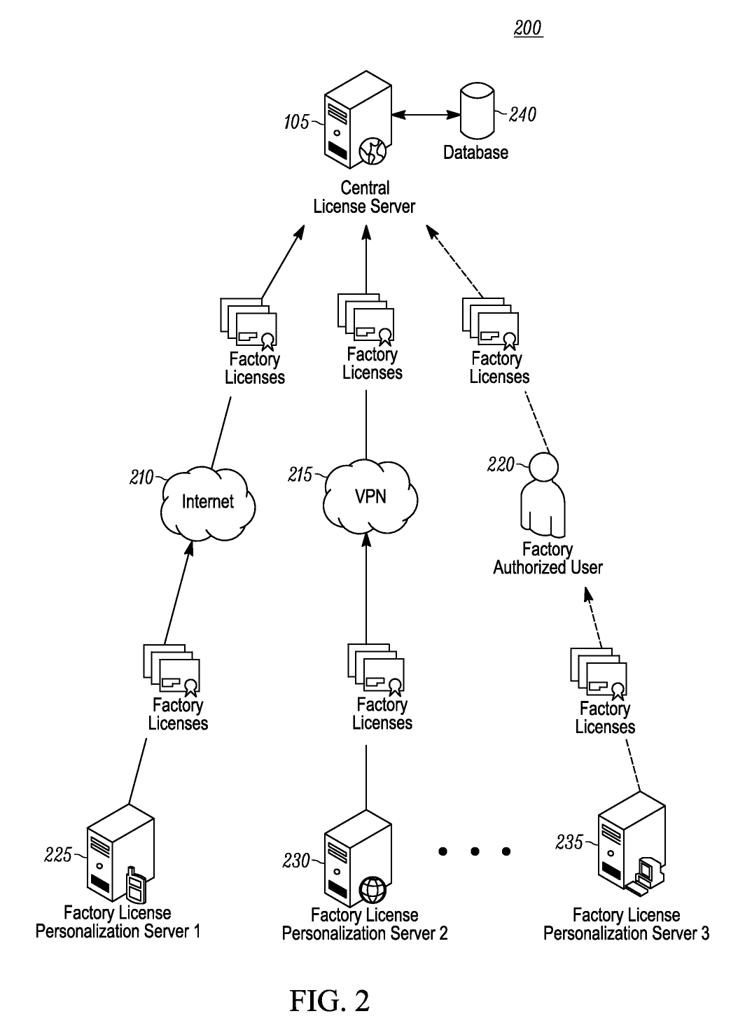

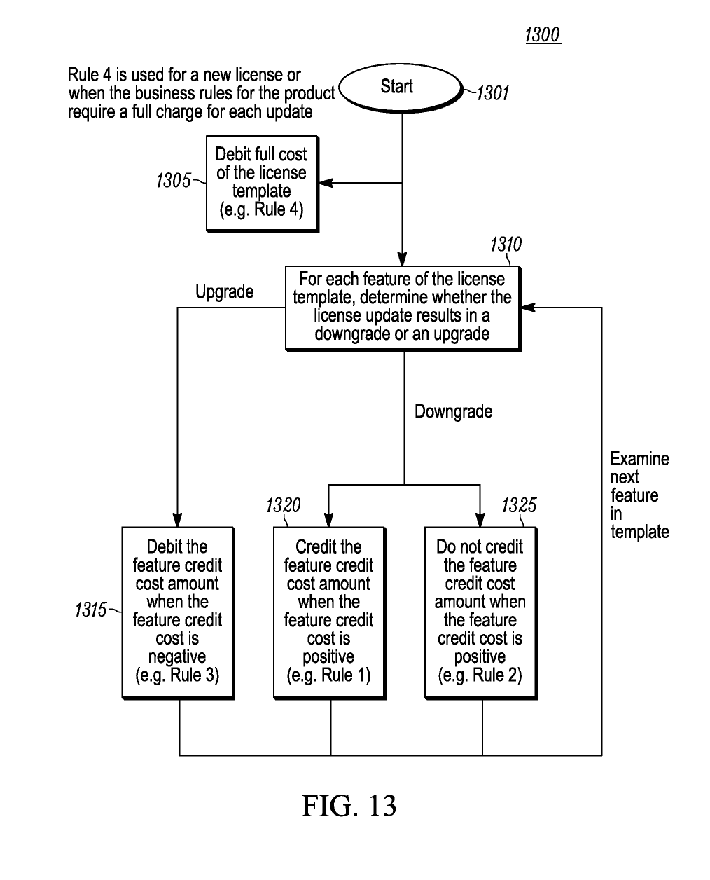

FIG. 2 illustrates one embodiment of a system 200 showing the importing of device initial licenses into the CLS either automatically or manually. CLS 105 may be connected to FLPS servers 225, 230, 235. CLS 105 may also be coupled to a database 240. An FLPS server is responsible for generating and loading the initial license onto a device in the factory. The connection between the CLS and FLPS may be direct or indirect. A direct connection may be made through a public WAN 210 or private network 215. An indirect connection 220 may occur through an intermediary application or even a manual process, e.g. factory authorized user 220. The connection is used to transfer every license generated by FLPS 225, 230, 235 into CLS 105. This information will be used to calculate feature credit balances in the license update process described later (See FIG. 13).

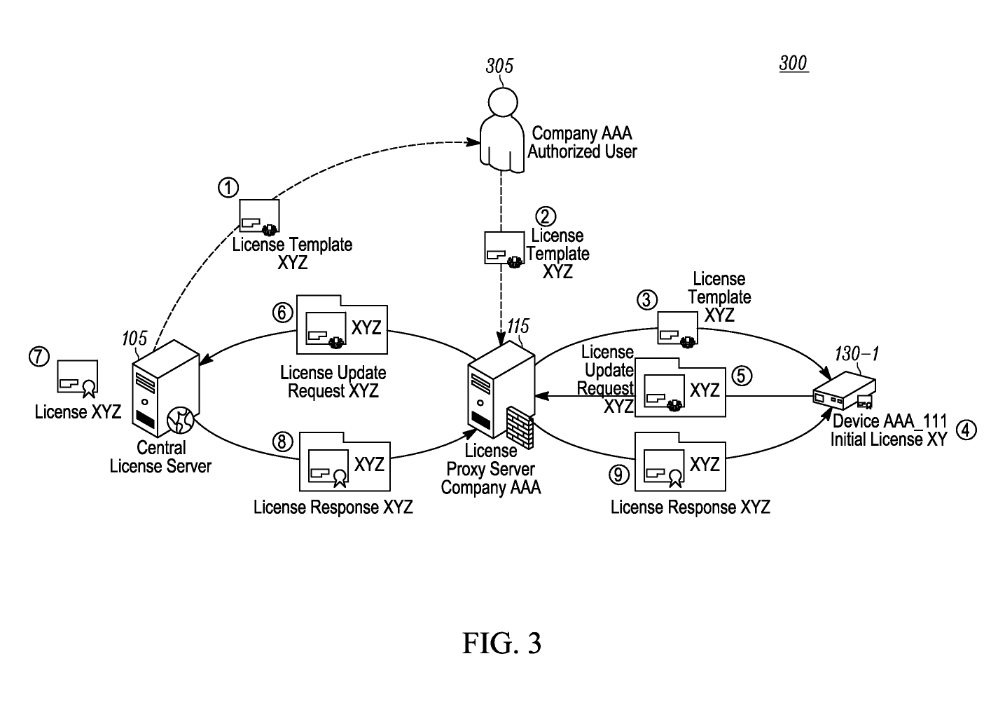

FIG. 3 illustrates one embodiment of a license update method 300 using a license proxy server. Method 300 begins with the generation of a license template on CLS 105. The license template contains the features the authorized user wants a device to enable. A license template is protected against alteration and can be verified that the CLS is its source.

In order to guard against alteration of the license template, the template is signed by an RSA (Rivest Shamir Adleman algorithm) private key. This private key is the same one used to sign and protect the license and is unique for whatever grouping, e.g. linkage, is used to segregate the feature credits a set of devices can use. The grouping is typically just a product, however, the grouping may also be a product and a geographic area (See ‘feature credit’ definition above). The signature ensures no alteration has been performed to the data in the template. Each device has the corresponding public key embedded in its software to verify the license templates and licenses the device uses. The purpose for preventing alteration and authenticating that a signature is from the correct key is to: 1) guarantee the source of the template (i.e. the CLS); and 2) link the template to the product group thereby preventing invalid templates (either altered or for a different product) from being used.

The private key used in the signature is protected and secured on the CLS and FLPS servers. The private key is not available outside of these servers. Only the CLS can generate the license template format (the FLPS servers do not have this logic). Therefore, any template with a valid signature from the private key must come from the CLS. As seen in step 1, authorized user 305 downloads the license template from CLS 105 and deploys the license template to LPS 115 (step 2). Step 3 transfers the license template from LPS 115 to device 130-1. This occurs through LPS 115 initiating contact with device 130-1 and sending the license template to device 130-1, or in response to a request for the latest license template from device 130-1.

In step 4, when device 130-1 receives a license template, device 130-1 compares the feature set in the template against the set of features enabled by a current license of device 130-1. If the features do not match, device 130-1 will generate a license update request. The license update request includes the received license template and a means of securely identifying the specific device, such as a digital certificate containing an identifier unique to the device.

The digital certificate is linked to a unique device key that signs the license update request. This prevents alteration and provides authentication that the license update request was generated by a device from a specific product line. If a unique device certificate is not available, a unique key, and optionally a certificate global to the product line, may be used by all devices in the product line. In this case, the global product key is separate from the product key used by the CLS to sign licenses and license templates.

In the case described by FIG. 3, the device compares its license (containing features X and Y) against the license template (containing features X, Y, and Z) and determines its license needs to be updated and therefore generates a license update request. The license update request is sent from device 130-1 to LPS 115 (step 5). LPS 115 then forwards the request to CLS 105 (step 6).

LPS 115 is provisioned with a Secure Sockets Layer (SSL) certificate that contains an identifier of the service provider who owns LPS 115. This certificate is used for Transport Layer Security (TLS) on the connection between LPS 115 and CLS 105, and for CLS 105 to identify which service provider the license update request is from, so that the CLS can make any necessary changes to the service provider's feature credit.

Once CLS 105 receives the license update request, CLS 105 will begin step 7 and go through the updated license generation process described in FIG. 13. The updated license is wrapped into a license response. The license response is optional to the design and is used primarily to include a status in addition to the updated license. If there was an error in the license generation process on the CLS including but not limited to failing to validate the license update request, having insufficient credit, or another error, the license response may contain an error status code and no license.

The license response is transmitted to LPS115 from CLS 105, in step 8, as a reply to the license update request. As shown in step 9, LPS 115 will then forward the response to the specific device 130-1 where the license update request originated. When device 130-1 receives the license response, device 130-1 will verify that the response is from CLS 105 and that the updated license contained within is from the CLS and for the specific device. If the validation passes, the device will install the new license (updated license) and delete its previous license (current license). When validating a feature license, e.g. the updated license, a device verifies a number of items including for example, the signature of the feature license, the product ID in the license (which should match the device's own product ID) and the device ID in the license (which should match the device's own device ID). The device may also verify that the timestamp in the license is not for a time in the future (to prevent clock rollback on the device). Likewise, when replacing an existing feature license, the validation process may also include a verification of the new license's sequence number to ensure that it is larger than the old license's sequence number. A device cannot load a license with a sequence number lower than its current license. This verification of the sequence number prevents old licenses from being used. Once the validation passes, the device will then enable the features authorized by the new updated license.

The LPS is responsible for distributing the currently license template to use for a set of devices on a network. It acts as a proxy between those devices and the CLS for license requests and responses. And it optionally provides an identifier to the CLS about which feature credit pool to use for a license request.

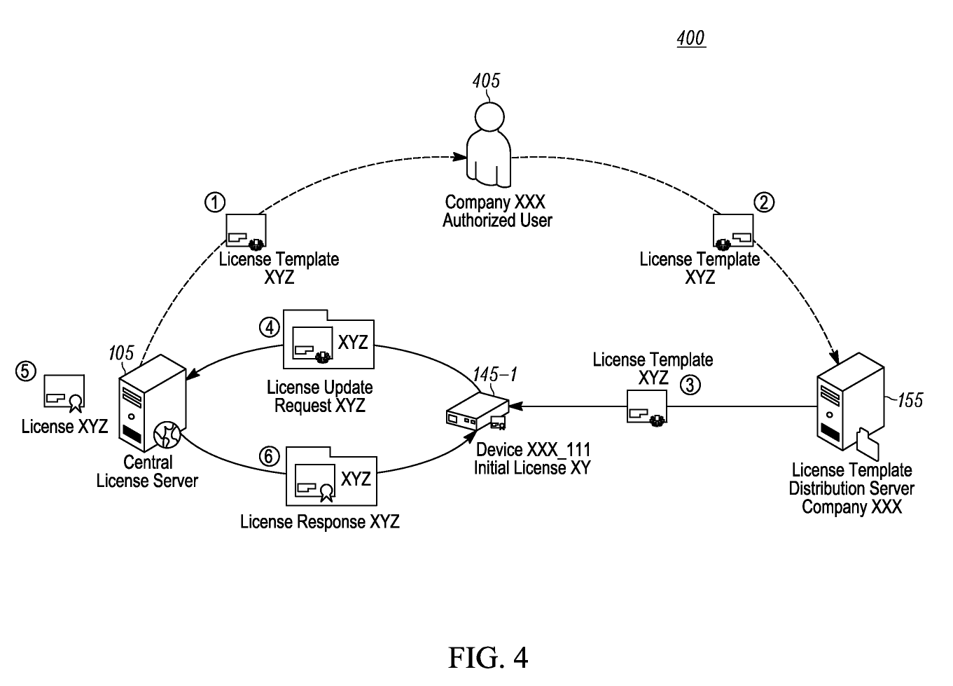

FIG. 4 illustrates one embodiment of a license update method 400 without a licensing proxy server and using a license template distribution server. In method 400, there is no LPS. To identify the service provider a license update request is for, either the license template in the request contains the service provider ID, or the device (e.g. device 145-1) is pre-registered with CLS 105 and linked with a single service provider. Pre-registration creates a device registration record in the CLS.

The process begins with the generation of a license template on CLS 105. In this case, the license template may include not only the features the authorized user wants a device to enable, but also an identifier of the service provider for which this template is going to be used.

Authorized user 405 then downloads the license template from CLS 105, as seen in step 1, and deploys the license template to LTDS 155 owned by the service provider (Company XXX), shown in step 2. LTDS 155 will then transmit the license template to device 145-1 (step 3) by initiating contact with the device and sending the license template to the device. The license template may also be transmitted by LTDS 155 to device 145-1 in response to a request for the latest license template from a device. In one embodiment, CLS 105 could also serve as the LTDS for some service providers.

When device 145-1 receives a license template, device 145-1 compares the feature set in the template against the set of features enabled by a current license of device 145-1. If the features do not match, device 145-1 will generate a license update request. When the device determines that its current license needs to be updated, the device generates a license update request that contains the received license template and a means of securely identifying the specific device, such as a digital certificate containing an identifier unique to the device. In this case, device 145-1 sends the license update request directly to CLS 105 (Step 4).

When CLS 105 receives a license update request over a connection without client SSL certificate, the CLS may determine the service provider from the license template in the update request or through a device registration record stored in CLS 105 linking the device ID to a specific service provider. The service provider operating device 145-1 must be determined in order to calculate any necessary changes to that service provider's feature credit balance.

Once CLS 105 receives the license update request, CLS 105 will begin step 5 and go through the updated license generation process described in FIG. 13. The updated license may be wrapped into a license response. The license response wrapper is optional to the design and is used primarily to include a status in addition to the updated license. If there was an error in the license generation process on the CLS including but not limited to failing to validate the license update request, having insufficient credit, or another error, the license response may contain an error status code and no license.

The license or license response is transmitted to device 145-1 from CLS 105, in step 6, as a reply to the license update request. When device 145-1 receives the license or license response, device 145-1 will verify that the license or license response is from CLS 105 and that the updated license is from the CLS and for the specific device. If the validation passes, the device will install the new license (updated license) and delete its previous license (current license). The device will then enable the features authorized by the new updated license.

The LTDS is a computer server that belongs to a customer in their operated network, and provides a central access point for all the customer's devices to receive updated license templates from the customer. Both the LTDS and the LPS are owned by the customer, however, the LTDS differs from the LPS in that the LPS acts as a proxy between individual devices and the CLS while the LTDS provides updated license templates for all devices in a customer's network but requires each device to communicate its License Request directly to the CLS itself. Because the LTDS is not involved in the License Request process for the devices it supports, unlike an LPS, it cannot provide a direct identifier to the CLS about which feature credit pool to use when servicing a request.

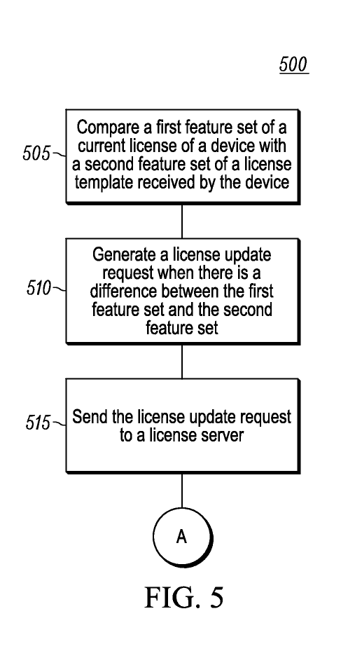

FIG. 5 illustrates a method 500 for providing a secure automated feature license update. Method 500 may be performed at devices 130-1 . . . 130-n, 140-1 . . . 140-m, 145-1 . . . 145-p. At step 505, a first feature set of a current license of a device is compared with a second feature set of a license template received by the device. At step 510, a license update request is generated when there is a difference between the first feature set and the second feature set. At step 515, the license update request is sent to a license server.

In one embodiment, the license update request includes the received license template and a secure identifier of the device. The secure identifier may be a digital certificate.

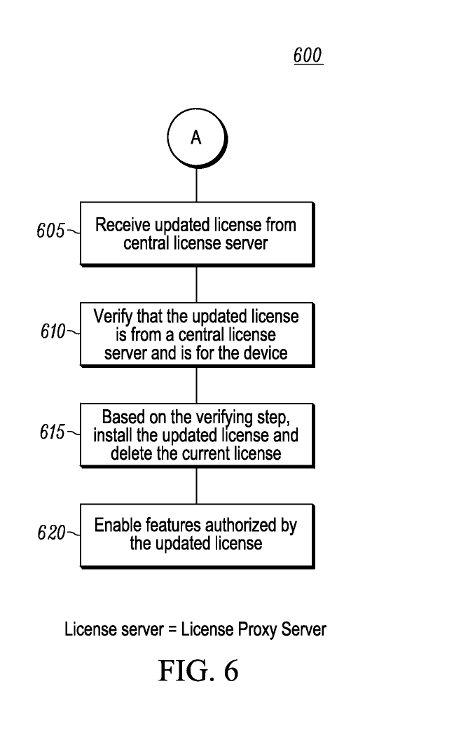

FIG. 6 illustrates an embodiment of a method 600 for receiving an updated license. In this embodiment, the license server of FIG. 5 is a LPS, e.g. LPS 115, and the license template is received by the device from the LPS. At step 605, an updated license is received from the LPS. At step 610, the device verifies that the updated license is from a central license server, e.g. CLS 105, and is for the device. At step 615, based on the verification step, the updated license is installed on the device and the previous current license is deleted. At step 620, features authorized by the updated license are enabled on the device.

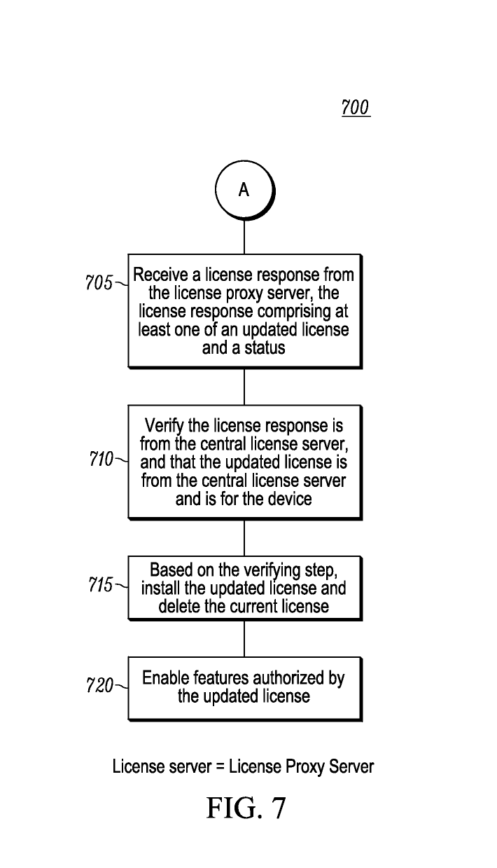

FIG. 7 illustrates an embodiment of a method 700 for receiving a license response. In this embodiment, the license server of FIG. 5 is a LPS, e.g. LPS 115, and the license template is received by the device from the LPS. At step 705, a license response is received from the LPS. The license response has at least one of an updated license and a status. At step 710, the device verifies that the license response is from a central license server, e.g. CLS 105. The device also verifies that the updated license is from the CLS and is for the device. At step 715, based on the verification step, the updated license is installed on the device and the previous current license is deleted. At step 720, features authorized by the updated license are enabled on the device.

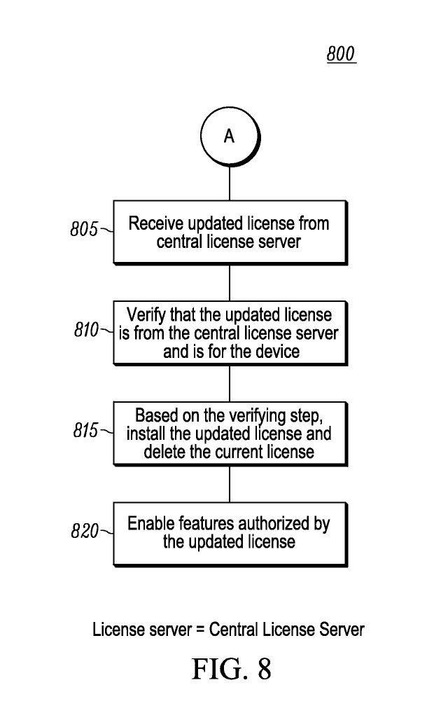

FIG. 8 illustrates an embodiment of a method 800 for receiving an updated license. In this embodiment, the license server of FIG. 5 is a central license server, e.g. CLS 105, and the license template is received by the device from a LTDS, e.g. LTDS 155. At step 805, an updated license is received from the CLS. At step 810, the device verifies that the updated license is from the CLS and is for the device. At step 815, based on the verification step, the updated license is installed and the previous current license is deleted. At step 820, features authorized by the updated license are enabled on the device.

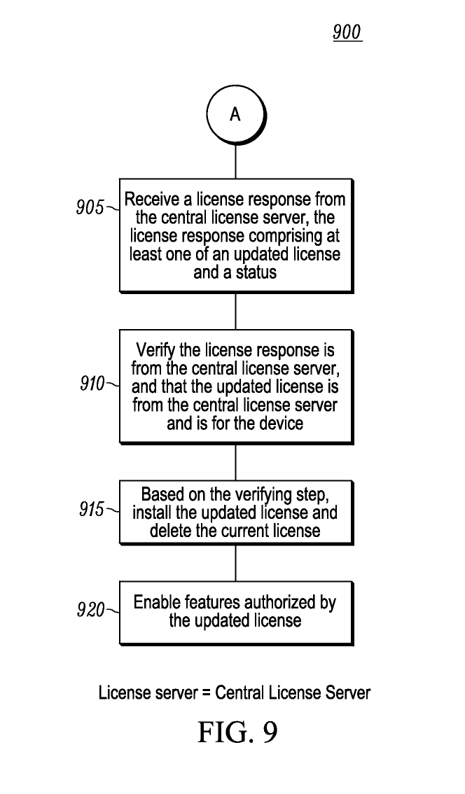

FIG. 9 illustrates an embodiment of a method 900 for receiving a license response. In this embodiment, the license server of FIG. 5 is a central license server, e.g. CLS 105, and the license template is received by the device from a LTDS, e.g. LTDS 155. At step 905, a license response is received from the CLS. The license response has at least one of an updated license and a status. At step 910, the device verifies that the license response is from the CLS. The device also verifies that the updated license is from the CLS and is for the device. At step 915, based on the verification step, the updated license is installed and the previous current license is deleted. At step 920, features authorized by the updated license are enabled on the device.

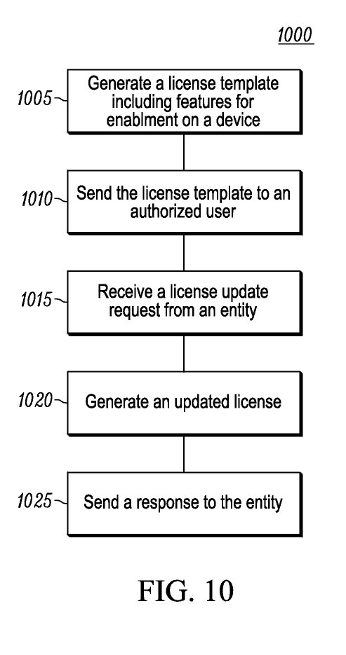

FIG. 10 illustrates a method 1000 for providing a secure automated feature license update. Method 1000 may be performed at CLS 105. At step 1005, a license template including features for enablement on a device is generated. At step 1010, the license template is sent to an authorized user. At step 1015, a license update request is received from an entity. At step 1020, an updated license is generated by the CLS. At step 1025, a response is sent to the entity.

In one embodiment, the entity is a license proxy server, e.g. LPS 115. The response may either be the updated license or a license response where the license response comprises at least one of an updated license and a status. In one embodiment, a license response includes only a status, e.g. when an error occurs and the license update cannot be generated.

In one embodiment, the entity is a device, e.g. device 145-1. The response may either be the updated license, or a license response, where the license response comprises at least one of an updated license and a status. In one embodiment, a license response includes only a status, e.g. when an error occurs and the license update cannot be generated.

The license template may be protected against alteration. The license template is signed by a unique product key. This signature prevents tampering and defines the scope of the authorization. The license template is valid for a certain product because it uses the product's signing key. The license template can also be verified to have originated from the central license server. Authenticating that a signature is from the correct key guarantees the source of the template (i.e. the CLS).

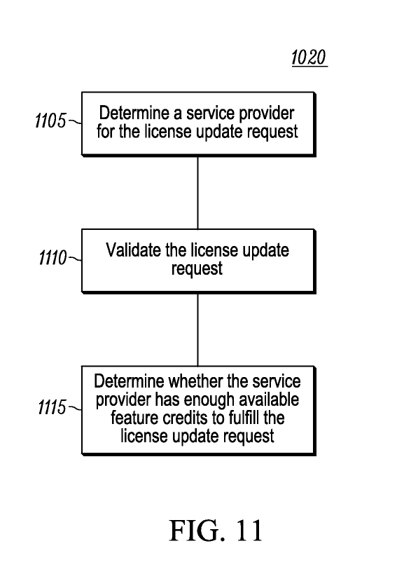

FIG. 11 illustrates one embodiment of a method 1020 for generating an updated license. At step 1105, a service provider for the license update request is determined. At step 1110, the license update request is validated. At step 1115, a determination is made as to whether the service provider has enough available feature credits to fulfill the license update request. In one embodiment, there is a linkage between the feature credits and the product and company they belong to (features can only be used for a specific product and only by a particular company's devices).

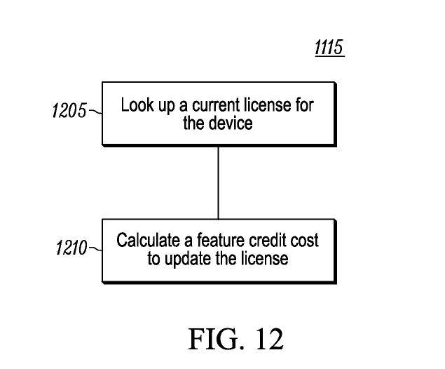

FIG. 12 illustrates one embodiment of a method 1115 for determining whether a service provider has enough available feature credits to fulfill a license update request. At step 1205, a current license for the device is looked up. At step 1210, a feature credit cost to update the license is calculated.

After the CLS receives a license update request, the CLS determines which service provider the request is for, either from the SSL certificate on the connection with an LPS, from the service provider ID in the license template in the request, or from a device registration record. Then, the CLS validates the license update request and checks to ensure the requesting service provider has enough feature credits available to fulfill the request. This available feature credit calculation begins by looking up the current license for the specific device. The CLS then calculates the feature credit cost to update the license.

In order to validate the license update request, the CLS verifies several attributes of the message. It verifies that the device identity certificate is issued from the trusted certificate chain for that particular product. It verifies that the license update request's signature using the public key contained in the device identity certificate. It also verifies that the request's license template was generated by the CLS (it can do this by verifying the templates signature and optionally by verifying that the template matches a value previously generated and stored in the CLS server's database.

Every product has a specific configuration that includes a specification for how feature updates should handle feature credit. The configuration can also allow a product to define different rules for updating licenses generated in the creation of a device by the FLPS than updating those generated by the CLS. Consider

Δ=Cost(LicenseFeatureᵢ)−Cost(TemplateFeatureᵢ)

where Δ is a feature credit cost, LicenseFeatureᵢ is a feature in the device's current license, and TemplateFeatureᵢ is the same feature in the license template in the license update request.

In one embodiment where feature credits are linked to a company, the rules available for updating existing factory licenses or CLS generated licenses include the following:

1. When a license update results in a downgrade for feature i, the positive Δ results in a credit in the amount of Δ to the feature credit balance of the company for feature i;
2. When a license update results in a downgrade for feature i, the positive Δ does not affect the feature credit balance of the company for feature i;
3. When a license update results in an upgrade for feature i, the negative Δ results in a debit in the amount of Δ to the feature credit balance of the company for feature i;
4. The full feature cost of the template for all features will be debited from the company regardless of Δ.

In the above embodiment, the feature credits are linked to a company. However, the feature credit may instead be linked across several different groupings such as product, location, company, date manufactured, and so forth. Rules may also be created within a grouping in order to allow different levels of access to the shared feature credit pool for a group. Different levels of access to the feature credit pool may be implemented by segregating among different device populations.

After an appropriate cost is determined for each feature in the template, the CLS will verify that the requesting company has the appropriate credits. The CLS can determine which company the device is associated with through several different methods including: 1) Binding the license template to a particular service provider; 2) Requiring each device to register its operator with the CLS before enabling automated updates; or 3) Binding the LPS to a particular company. Methods 1) and 2) may be used for the “Template Distribution Server” process shown in FIG. 4. Method 3) is used for the proxy-based license update process of FIG. 3 as the LPS is bound to company AAA. This binding may be accomplished by including the company association in the server's TLS client certificate. If the company has the necessary feature credits, the CLS will generate a license with the appropriate features. The generated license will be set as the active license for the device, revoking all previously generated licenses for the device, in CLS and the feature credits for the requesting company will be credited and debited according to the rules set in the product configuration.

FIG. 13 illustrates one embodiment of a method 1300 for calculating a feature credit cost. Method 1300 begins at step 1301. Method 1300 proceeds to either step 1305 or step 1310. At step 1305, the full cost of the license template is debited from a company (e.g., in accordance with Rule 4).

At step 1310, for each feature of a license template, a determination is made as to whether a license update results in an upgrade or a downgrade. When the result for a particular feature is an upgrade, at step 1315, the feature credit cost amount is debited when the feature credit cost is negative (e.g. in accordance with Rule 3).

When the result for a particular feature is a downgrade, the feature credit cost amount may be credited when the feature credit cost is positive at step 1320 (e.g. in accordance with Rule 1) or not credited when the feature credit cost is positive at step 1325 (e.g. in accordance with Rule 2).

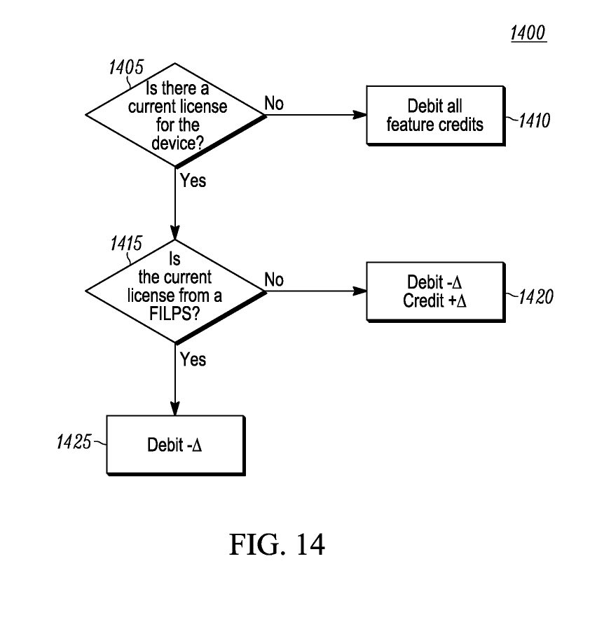

FIG. 14 illustrates an example feature credit calculation method 1400. At step 1405, a determination is made as to whether there is a current license for the device. If there is no current license for the device, all feature credits for the features in the license template are debited (step 1410). If there is a current license for the device, a determination is made as to whether the current license is from an FLPS. If the current license is not from an FLPS, e.g. the current license is from a CLS, negative Δ is debited and positive Δ is credited (step 1320). If the current license is from an FLPS, negative Δ is debited (step 1325).

Generally, Rule 2 may be used when feature credits are not refunded for downgrades. Rule 4 may be used for the first license generated for a device or can be used as an option to make every license update cost its entire amount in new feature credits (e.g., when feature credits cannot be reused). In FIG. 14, rules 1 and 3 are applied for licenses generated by CLS while only rule 3 is applied when updating licenses generated by an FLPS.

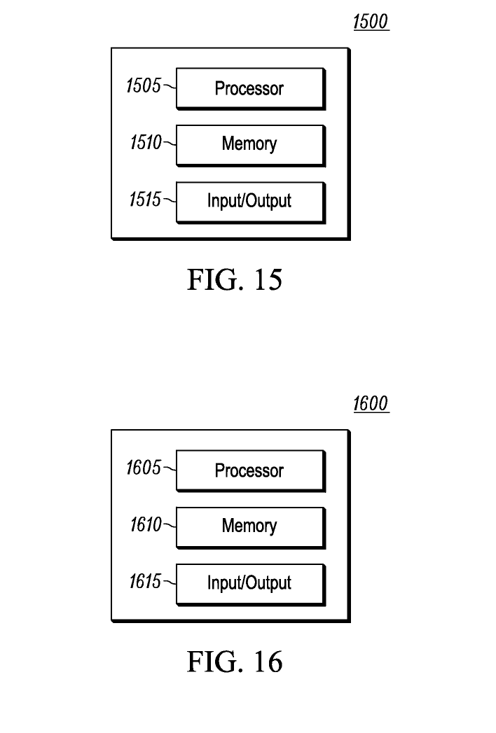

FIG. 15 and FIG. 16 illustrate an example server device 1500 and end-user device 1600. Server device 1500 may be implemented as central license server 105, license proxy server 115, license template distribution server 155, or factory license personalization server 225, 230, 235. Device 1500 comprises a processor (CPU) 1505, a memory 1510, e.g., random access memory (RAM) and/or read only memory (ROM), and various input/output devices 1515, (e.g., storage devices, including but not limited to, a tape drive, a floppy drive, a hard disk drive or a compact disk drive, a receiver, a transmitter, and other devices commonly required in multimedia, e.g., content delivery, encoder, decoder, system components, Universal Serial Bus (USB) mass storage, network attached storage, storage device on a network cloud).

End-user device 1600 may be implemented as devices (130-1 . . . 130-n, 140-1 . . . 140-m, or 145-1 . . . 145-p). Device 1600 comprises a processor (CPU) 1605, a memory 1610, e.g., random access memory (RAM) and/or read only memory (ROM), and various input/output devices 1615, (e.g., storage devices, including but not limited to, a tape drive, a floppy drive, a hard disk drive or a compact disk drive, a receiver, a transmitter, and other devices commonly required in multimedia, e.g., content delivery, encoder, decoder, system components, Universal Serial Bus (USB) mass storage, network attached storage, storage device on a network cloud).

The processes described above, including but not limited to those presented in connection with FIGS. 2-14, may be implemented in general, multi-purpose or single purpose processors. Such a processor, e.g. processor 1505, 1605, will execute instructions, either at the assembly, compiled or machine-level, to perform that process. Those instructions can be written by one of ordinary skill in the art following the description of presented above and stored or transmitted on a computer readable medium, e.g., a non-transitory computer-readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

Some advantages of the present disclosure are as follows: 1) Deploying a license template to LPS or LTDS and automatically delivering it to devices to initiate the license update process enables a deployed device to create a license update request specifically for the device, providing end-to-end matching between license update request and the updated license that is eventually installed on the device; 2) The binding of an LPS to a service provider, the inclusion of a service provider ID in a license template, or the linking of a device with a service provider provides the CLS with the service provider that requested the license update. With the service provider identity of a license update request, the CLS can manage the feature credit of the correct service provider; 3) The calculation of the differences in feature set between a license template in a device's license update request and the device's current license ensures the correct accounting of feature credits used by any updated license; 4) The feature set comparison a device does between its current license and the license template it receives from either an LPS or an LTDS will ensure that if there is no difference between the two, no license update request will be sent.

While the foregoing is directed to embodiments of the present disclosure, other and further embodiments may be devised without departing from the basic scope thereof, and the scope thereof is determined by the claims that follow.

What is claimed is:

1. A method, performed at a device, for providing a secure automated feature license update, comprising:
comparing a first feature set of a current license of the device with a second feature set of a license template received by the device;
generating a license update request when there is a difference between the first feature set and the second feature set; and
sending the license update request to a license server.

2. The method of claim 1, wherein the license server comprises a license proxy server and wherein the license template is received by the device from the license proxy server.

3. The method of claim 2, further comprising:
receiving an updated license from the license proxy server;
verifying that the updated license is from a central license server and is for the device;
based on the verifying step, installing the updated license and deleting the current license; and
enabling features authorized by the updated license.

4. The method of claim 2, further comprising:
receiving a license response from the license proxy server, the license response comprising at least one of an updated license and a status;
verifying that the license response is from the central license server, and that the updated license is from the central license server and is for the device;
based on the verifying step, installing the updated license and deleting the current license; and
enabling features authorized by the updated license.

5. The method of claim 1, wherein the license server comprises a central license server and wherein the license template is received by the device from a license template distribution server.

6. The method of claim 5, further comprising:
receiving an updated license from the central license server;
verifying that the updated license is from the central license server and is for the device;
based on the verifying step, installing the updated license and deleting the current license; and
enabling features authorized by the updated license.

7. The method of claim 5, further comprising:
receiving a license response from the central license server, the license response comprising at least one of an updated license and a status;
verifying that the license response is from the central license server, and that the updated license is from the central license server and is for the device;
based on the verifying step, installing the updated license and deleting the current license; and
enabling features authorized by the updated license.

8. The method of claim 1, wherein the license update request includes the received license template and a secure identifier of the device.

9. The method of claim 8, wherein the secure identifier is a digital certificate.

10. A method, performed at a central licensing server, for providing a secure automated feature license update, comprising:
generating a license template comprising features for enablement on a device;
sending the license template to an authorized user;
receiving a license update request from an entity;
generating an updated license; and
sending a response to the entity.

11. The method of claim 10, wherein the entity comprises a license proxy server.

12. The method of claim 11, wherein the response comprises the updated license.

13. The method of claim 11, wherein the response is a license response, the license response comprising at least one of an updated license and a status.

14. The method of claim 13, wherein the license response comprises only a status.

15. The method of claim 10, wherein the entity comprises the device.

16. The method of claim 15, wherein the response comprises the updated license.

17. The method of claim 15, wherein the response is a license response, the license response comprising at least one of an updated license and a status.

18. The method of claim 17, wherein the license response comprises only a status.

19. The method of claim 10, wherein the license template is protected against alteration.

20. The method of claim 10, wherein the license template can be verified to have originated from the central license server.

21. The method of claim 10, wherein generating an updated license comprises:
determining a service provider for the license update request;
validating the license update request; and
determining whether the service provider has enough available feature credits to fulfill the license update request.

22. The method of claim 21, wherein determining available feature credits comprises:
looking up a current license for the device; and
calculating a feature credit cost to update the license.
